(19) United States
(12) Patent Application Publication
(10) Pub. No.: US 2010/0183973 A1
(43) Pub. Date: Jul. 22, 2010

(54) PHOTOCONDUCTIVE LAYER MANUFACTURING METHOD

(75) Inventor: Kohei HIGASHI, Ashigarakami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/688,533

(22) Filed: Jan. 15, 2010

(30) Foreign Application Priority Data
Jan. 19, 2009 (JP) 008382/2009
Oct. 16, 2009 (JP) 238853/2009

(51) Int. Cl. G03G 5/04

(52) U.S. Cl. 430/127

(57) ABSTRACT

A method for manufacturing a photoconductive layer formed of Bi₁₂MO₂₀ particles (M is at least one of Si, Ge, and Ti) and constitutes a radiation imaging panel for recording radiation image information as an electrostatic latent image. The method includes the steps of molding a powder compact of Bi₁₂MO₂₀ particles, impregnating the powder compact with a macromolecular substance, and solidifying the macromolecular substance.

### BACKGROUND OF THE INVENTION

1. Field of the Invention

The present invention relates to a method for manufacturing a photoconductive layer constituting a radiation imaging panel.

2. Description of the Related Art

In the field of medical X-ray radiography, X-ray imaging panels are known. The X-ray imaging panel uses an X-ray sensitive photoconductive layer as a photoconductor, in order to improve diagnostic capabilities with a reduced amount of radiation received by a subject, and an electrostatic latent image formed by the X-rays on the photoconductive layer is read out by light or multitudes of electrodes and recorded. The method described above is superior to the known image projection method called indirect imaging using TV camera tube, in that it may obtain higher resolution.

The X-ray imaging panel described above includes therein a charge generation layer that receives X-rays and generates charges corresponding to the received X-ray energies, and the generated charges are read out as electrical signals. The photoconductive layer described above functions as the charge generation layer.

Bi₁₂MO₂₀ (M is at least one of Si, Ge, and Ti) is preferable as a material of a radiation sensitive photoconductor, as it has a high X-ray absorption rate, low toxicity, and high chemical stability, and used in a photoconductive layer in the form of a Bi₁₂MO₂₀ polycrystalline body or a coating film in which Bi₁₂MO₂₀ particles are dispersed in a resin binder or the like. For example, Japanese Unexamined Patent Publication No. 2006-096657 describes a method for manufacturing a photoconductive layer through the steps of mixing a mixed solution of bismuth salt and metal alkoxide with an alkali water solution to obtain a Bi₁₂MO₂₀ precursor, molding the obtained Bi₁₂MO₂₀ precursor, and baking the molded Bi₁₂MO₂₀ precursor. A photoconductive layer manufactured by the method described above is a sintered body having a dense layer and high collection efficiency of generated charges, whereby the sensitivity is increased. Further, the photoconductive layer has a high filling rate so that the X-ray absorption rate is increased which provides advantageous effects that the readout speed of the radiation imaging panel is increased and dark current is reduced even when the thickness of the photoconductive layer is reduced.

While having excellent properties described above, the photoconductive layer described in Japanese Unexamined Patent Publication No. 2006-096657 has a drawback that the layer is fragile because of a sintered body and susceptible to physical impact, causing low handleability. From the viewpoint of handleability, the coating film in which Bi₁₂MO₂₀ particles are dispersed in a resin binder or the like is preferable, but this will result in a low filling rate of a radiation/charge conversion material, thereby posing a problem of low sensitivity (a small amount of charges generated).

The present invention has been developed in view of the circumstances described above, and it is an object of the present invention to provide a method for manufacturing a photoconductive layer capable of manufacturing a high sensitivity photoconductive layer resistant to physical impact and has a higher filling rate than that of a photoconductive layer of a particle dispersion type coating film.

### SUMMARY OF THE INVENTION

A method for manufacturing a photoconductive layer of the present invention is a method for manufacturing a photoconductive layer formed of Bi₁₂MO₂₀ particles (M is at least one of Si, Ge, and Ti) and constitutes a radiation imaging panel for recording radiation image information as an electrostatic latent image, the method including the steps of molding a powder compact of Bi₁₂MO₂₀ particles, impregnating the powder compact with a macromolecular substance, and solidifying the macromolecular substance. The method of the present invention may be embodied to further include the step of slicing the powder compact with the solidified macromolecular substance.

Preferably, the Bi₁₂MO₂₀ particles are heat treated at a temperature in the range from 500° C. to 870° C. before being molded into the powder compact. Preferably, the macromolecular substance is a thermosetting resin, an ultraviolet curable resin, or an electron beam curable resin. Preferably, the powder compact is molded by uniaxial pressing and cold isostatic pressing, or either the uniaxial pressing or the cold isostatic pressing.

According to the method for manufacturing a photoconductive layer of the present invention, a photoconductive layer is manufactured by molding a powder compact of Bi₁₂MO₂₀ particles, impregnating the powder compact with a macromolecular substance, and solidifying the macromolecular substance impregnated in the powder compact. This allows a structure in which the macromolecular substance is present in a space between Bi₁₂MO₂₀ particles, whereby a photoconductive layer resistant to physical impact may be manufactured. Further, a powder compact of Bi₁₂MO₂₀ particles is formed and the powder compact is impregnated with a macromolecular substance, so that a photoconductive layer having a higher filling rate of Bi₁₂MO₂₀ particles and a higher sensitivity in comparison with a particle dispersion type coating film may be manufactured. Further, according to the method of the present invention, a photoconductive layer resistant to physical impact may be manufactured. Consequently, the manufactured photoconductive layer becomes processable, which allows, for example, a mode of manufacturing in which photoconductive layers are manufactured by slicing a powder compact with a solidified macromolecular substance, so that a mass production may be realized easily.

### BRIEF DESCRIPTION OF THE DRAWINGS

FIGS. 1A to 1E are schematic views illustrating the steps of photoconductive layer manufacturing method according to an embodiment of the present invention.

FIGS. 2A to 2F are schematic views illustrating the steps of photoconductive layer manufacturing method according to another embodiment of the present invention.

FIG. 3 is a schematic view of an embodiment of a manufacturing apparatus usable for manufacturing Bi₁₂MO₂₀ particles.

### DESCRIPTION OF THE PREFERRED EMBODIMENTS

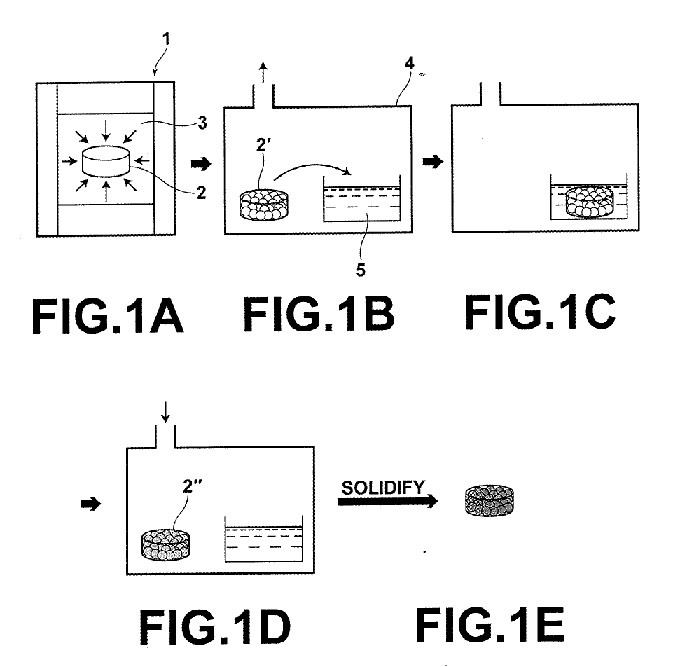

Hereinafter, a method for manufacturing a photoconductive layer of the present invention will be described with reference to the accompanying drawings. FIGS. 1A to 1E are schematic views illustrating the steps of photoconductive layer manufacturing method according to an embodiment of the present invention. First, a pellet of Bi₁₂MO₂₀ particles is formed by a uniaxial press (not shown). Preferably, Bi₁₂MO₂₀ particles are subjected to a heat treatment at a temperature in the range from 500° C. to 870° C. before being pelleted (before being compacted). In this case, the heat treatment after the Bi₁₂MO₂₀ particles are compacted is undesirable because fusion occurs between compacted Bi₁₂MO₂₀ particles and the compact becomes like a sintered body, resulting in fragile and low handleability.

Use of the heat-treated Bi₁₂MO₂₀ particles reduces grain boundaries of Bi₁₂MO₂₀ particles, which prevents carries from being trapped when radiation is generated, whereby the amount of generated charges may be increased. Consequently, the radiation sensitive photoconductor manufactured using the particles may have a high sensitivity and a high S/N ratio. Note that the amount of generated charges in a radiation sensitive photoconductor using Bi₁₂MO₂₀ particles subjected to a heat treatment with a temperature less than 500° C. is substantially the same as that of a radiation sensitive photoconductor using Bi₁₂MO₂₀ particles not subjected to a heat treatment. On the other hand, a heat treatment with a temperature higher than 870° C. melts Bi₁₂MO₂₀ particles, since the melting point of Bi₁₂MO₂₀ particles is about 880° C., and crystal dissolution occurs. Note that, however, the photoconductive layer manufacturing method of the present invention may use slightly fused Bi₁₂MO₂₀ particles without any problem if the fused Bi₁₂MO₂₀ particles can be crushed at the time of preparing the pellet.

The prepared pellet is put in a cold isostatic press 1. Cold isostatic press 1 is an apparatus capable of performing a cold isostatic pressing (also known as CIP method, cold isostatic press molding, or isostatic press) in which prepared pellet 2 of Bi₁₂MO₂₀ particles is isotropically pressed by a hydrostatic pressure via pressure conveying fluid 3 without heating, whereby Bi₁₂MO₂₀ particles are solidified and molded. In this way a powder compact of Bi₁₂MO₂₀ particles is formed (FIG. 1A). There is not any specific restriction on the applied pressure as long as it is capable of forming a powder compact, but it is preferable that the pressure is in the range from about 10 MPa to about 700 MPa, and more preferably in the range from 20 MPa to 200 MPa in order to obtain a filling rate of Bi₁₂MO₂₀ particles of 60% or more.

Next, powder compact 2′ of Bi₁₂MO₂₀ particles is moved to vacuum vessel 4. Macromolecular substance 5 to be impregnated in powder compact 2′ of Bi₁₂MO₂₀ particles is provided in vacuum vessel 4 in advance (FIG. 1B). The inside of vacuum vessel 4 is vacuumed by a pump (not shown). Thereafter, powder compact 2′ of Bi₁₂MO₂₀ particles is immersed in macromolecular substance 5 (FIG. 1C). This will cause macromolecular substance 5 to be impregnated in powder compact 2′ of Bi₁₂MO₂₀ particles.

Then, powder compact 2″ of Bi₁₂MO₂₀ particles is taken out from macromolecular substance 5 and the inside of the vacuum vessel 4 is returned to the atmospheric pressure (FIG. 1D). Powder compact 2″ of Bi₁₂MO₂₀ particles is taken out from vacuum vessel 4 and powder compact 2″ of Bi₁₂MO₂₀ particles impregnated with the macromolecular substance is solidified after excess macromolecular substance is removed (FIG. 1E). Through the process described above, a photoconductive layer of powder compact of Bi₁₂MO₂₀ particles impregnated with the macromolecular substance may be manufactured. If pellet 2 of Bi₁₂MO₂₀ particles is provided, for example, in the form a sheet having a desired thickness, the sheet may be used directly as a photoconductive layer.

Here, the description has been made of a case in which a pellet is formed by uniaxial pressing and a powder compact of Bi₁₂MO₂₀ particles is formed by a CIP method, but the powder compact of Bi₁₂MO₂₀ particles may be formed by either one of the uniaxial pressing and CIP method. From the viewpoint of increasing the filling rate of Bi₁₂MO₂₀ particles, however, the combined use of the uniaxial pressing and CIP method is preferable.

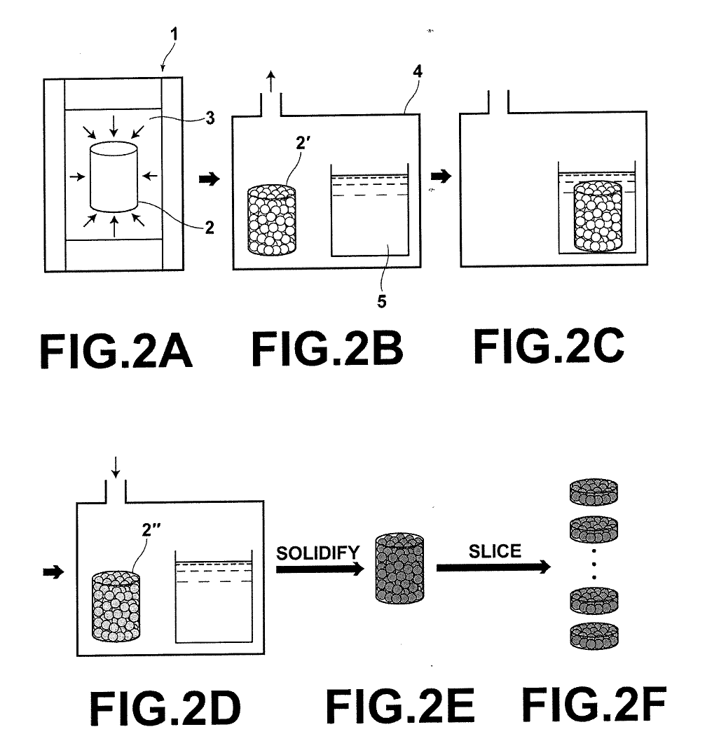

In FIGS. 1A to 1E, a manufacturing mode in which powder compact 2″ of Bi₁₂MO₂₀ particles is used directly as a photoconductive layer has been described. Next, a manufacturing mode more suitable for mass production will be described with reference to FIGS. 2A to 2F. FIGS. 2A to 2F are schematic views illustrating the steps of photoconductive layer manufacturing method according to another embodiment of the present invention. In FIGS. 2A to 2F, components identical to those in FIGS. 1A to 1E are given the same reference numerals and will not be elaborated upon further here, unless otherwise specifically required. First, pellet 2 of Bi₁₂MO₂₀ particles is prepared by uniaxial pressing. This pellet, unlike the pellet shown in FIG. 1, is prepared with a thickness large enough to cut out a plurality of photoconductive layers.

Through the steps of FIGS. 2A to 2E similar to those of FIGS. 1A to 1E, a photoconductive layer of powder compact of Bi₁₂MO₂₀ particles impregnated with the macromolecular substance is manufactured. By slicing the photoconductive layer of powder compact of Bi₁₂MO₂₀ particles impregnated with the macromolecular substance at a desired thickness, a plurality of photoconductive layers may be manufactured at a time (FIG. 2F). The conventional Bi₁₂MO₂₀ sintered body is physically fragile, so that the body can not be sliced in the manner as described above, and the photoconductive layer of particle dispersion type coating film is also manufactured one at a time, requiring time. But, the manufacturing method of the present invention can meet mass production requirements since it is capable of manufacturing a plurality of photoconductive layers at a time.

Macromolecular substances preferably used in the manufacturing method of the present invention include thermosetting resins and active energy ray curable resins, such as ultraviolet curable resins and electron beam curable resins. Preferable thermosetting resins include RTV rubbers, phenolic resins, amino resins, urea-formaldehyde resins, melamine resins, benzoguanamine resins, polyamide resins, epoxy resins, and the like. These thermosetting resins may be solidified by heating them.

Ultraviolet curable resins and electron beam curable resins may be cited as typical active energy ray curable resins, but resins solidified by active energy rays other than ultraviolet rays and electron beams may also be used. Active energy ray curable resins may be solidified through cross-linking reaction by exposing them to active energy rays, such as ultraviolet rays and electron beams.

Preferable ultraviolet curable resins include UV curing acrylic urethane resins, UV curing polyester acrylate resins, UV curing epoxy acrylate resins, UV curing polyol acrylate resins, UV curing epoxy resins, and the like. These UV curing resins may be solidified by exposing them to ultraviolet rays. Preferable electron beam curable resins include acrylic resins and epoxy resins.

There is not any specific restriction on the manufacturing method of Bi₁₂MO₂₀ particles used in the manufacturing method of the present invention. For example, Bi₁₂MO₂₀ particles manufactured by the following method may be used. A Bi element solution and an M element solution are provided first. The Bi element solution is prepared by dissolving a Bi source, a Bi containing compound, in a solvent. As for the Bi source, compounds, such as bismuth nitrate, bismuth carbonate, bismuth acetate, bismuth phosphate, bismuth trifluoride, bismuth trichloride, bismuth tribromide, bismuth triiodide, bismuth hydroxide, bismuth oxycarbonate, bismuth oxychloride, tri-i-propoxy bismuth (Bi(O-i-C₃H₇)₃), triethoxybismuth (Bi(OC₂H₅)₃), bismuth tri-t-amiloxide (Bi(O-t-C₅H₁₁)₃), triphenylbismuth (Bi(C₆H₅)₃), bismuth tris(dipivaloylmethanate) (Bi(C₁₁H₁₉O₂)₃), bismuth oxide, and the like may be used.

The M element solution is prepared by dissolving an M source, an M containing compound, in a solvent. When the M element is Si, preferable Si sources include silicon tetrachloride, silicon tetrabromide, silicon tetraiodide, silicon acetate, silicon oxalate, sodium orthosilicate, potassium orthosilicate, sodium metasilicate, potassium metasilicate, sodium silicate, potassium silicate, calcium silicate, sodium disilicate, potassium disilicate, hexafluorosilicate, ammonium hexafluorosilicate, sodium hexafluorosilicate, potassium hexafluorosilicate, silicon monoxide, silicon dioxide (crystalline), silicon dioxide (amorphous), colloidal silica, tetramethoxysilane (Si(OCH₃)₄), tetraethoxysilane (Si(OC₂H₅)₄), tetra-i-propoxysilane (Si(O-i-C₃H₇)₄), tetra-n-propoxysilane (Si(O-n-C₃H₇)₄), tetra-i-butoxysilane (Si(O-i-C₄H₉)₄), tetra-n-butoxysilane (Si(O-n-C₄H₉)₄), tetra-sec-butoxysilane (Si(O-sec-C₄H₉)₄), tetra-t-butoxysilane (Si(O-t-C₄H₉)₄), SiH[N(CH₃)₂]₃, SiH[N(C₂H₅)₂]₃, and the like.

When the M element is Ge, preferable Ge sources include germanium tetrachloride, germanium tetrabromide, germanium tetraiodide, germanium acetate, germanium oxalate, sodium orthogermanate, potassium orthogermanate, sodium metagermanate, potassium metagermanate, sodium germinate, potassium germinate, calcium germinate, sodium digermanate, potassium digermanate, hexafluorogermanate, ammonium hexafluorogermanate, sodium hexafluorogermanate, potassium hexafluorogermanate, germanium dioxide, tetramethoxygermanium (Ge(OCH₃)₄), tetraethoxygermanium (Ge(OC₂H₅)₄), tetra-i-propoxygermanium (Ge(O-i-C₃H₇)₄), tetra-n-propoxygermanium (Ge(O-n-C₃H₇)₄), tetra-i-butoxygermanium (Ge(O-i-C₄H₉)₄), tetra-n-butoxygermanium (Ge(O-n-C₄H₉)₄), tetra-sec-butoxygermanium (Ge(O-sec-C₄H₉)₄), tetra-t-butoxygermanium (Ge(O-t-C₄H₉)₄), and the like.

When the M element is Ti, preferable Ti sources include titanium tetrachloride, titanium tetrabromide, titanium tetraiodide, titanium acetate, titanium oxalate, sodium titanate, potassium titanate, calcium titanate, hexafluorotitanate, ammonium hexafluorotitanate, sodium hexafluorotitanate, potassium hexafluorotitanate, titanium dioxide, tetramethoxytitanium (Ti(OCH₃)₄), tetraethoxytitanium (Ti(OC₂H₅)₄), tetra-i-propoxytitanium (Ti(O-n-C₃H₇)₄), tetra-n-propoxytitanium (Ti(O-n-C₃H₇)₄), tetra-i-butoxytitanium (Ti(O-i-C₄H₉)₄), tetra-n-butoxytitanium (Ti(O-n-C₄H₉)₄), tetra-sec-butoxytitanium (Ti(O-sec-C₄H₉)₄), tetra-t-butoxytitanium (Ti(O-t-C₄H₉)₄), Ti[N(CH₃)₂]₄, Ti[N(C₂H₅)₂]₄, and the like.

As for the solvents for dissolving the Bi source and M source, water or organic solvents, typically alcohols, are preferably used, of which water is more preferable because of low cost. Preferably, a prepared solution is acidified since Bi element substantially does not dissolve in an alkaline water solution. Where an acid is used for acidifying the solution, any acid may be used. For example, inorganic acids, such as hydrochloric acids, sulfuric acids, nitric acids, phosphoric acids, boric acids, and hydrofluoric acids or organic acids, such as formic acids, acetic acids, oxalic acids, citric acid, and the like may be used.

In order to finally obtain Bi₁₂MO₂₀ as a deposit, however, it is preferable that the mixed solution is alkalified and has a low Bi solubility. Thus, it is preferable that the solution dissolving the M source is alkalified. Here, preferable alkali compounds for alkalifying the solution include, for example, LiOH, KOH, NaOH, RbOH, ammonia, and NR₄OH (R is alkyl group).

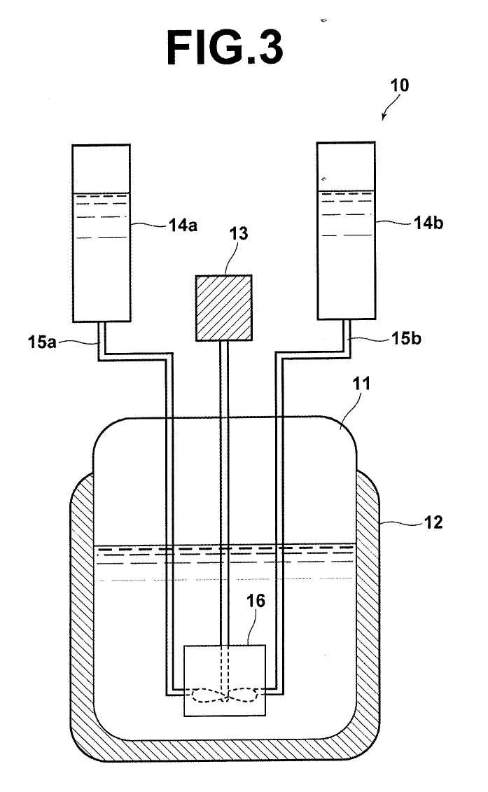

FIG. 3 is a schematic sectional view of reactor 10 suitable for a manufacturing method of Bi₁₂MO₂₀ particles, illustrating the configuration thereof. As shown in FIG. 3, reactor 10 includes reaction vessel 11 for reacting a mixture by heating and agitating the mixture, temperature controller 12 for heating reaction vessel 11, motor 13 and agitation unit 16 for agitating the reaction solution, solution tank 14a for containing a solution including Bi element, solution flow path 15a for supplying the Bi solution to reaction vessel 11, solution tank 14b for containing a solution including M element, and solution flow path 15b for supplying the M solution to reaction vessel 11.

First, Bi solution and M solution are put in solution tanks 14a and 14b respectively, and an amount of mother liquor is put in reaction vessel 11 such that agitation unit 16 is just or sufficiently immersed. The mother liquor may not include Bi element and M element or may include a portion of total amount of Bi or M element as required. As for the mother liquor, water or organic solvents, typically alcohols, may be used, and it is preferable that the mixed solution is alkalified and has a low Bi solubility in order to obtain Bi₁₂MO₂₀ as a deposit. Therefore, it is preferable that the mother liquor is alkalified and the alkali compounds for alkalifying the solution dissolving the M source described above may be used for this purpose.

Next, temperature controller 12 is activated to adjust the temperature of the mother liquor to 25° C. to 75° C. This temperature range allows Bi₁₂MO₂₀ particles to be obtained by several hours of reaction. Then, the Bi solution and M solution are introduced in reaction vessel 11. The reaction solution is agitated by agitation unit 16 to accelerate mixing, reaction, and homogenization by circulation. Preferably, the addition of Bi and M solutions is performed such that the substance amounts of Bi and M elements increase in parallel from the start of the addition, that is, the substance amounts of Bi and M elements during or after completion of the addition are increased in comparison with those just after the start of the addition.

Preferably, the addition of the solutions is performed by gradually increasing the temperature of the mixed solution from the start of mixing. The start of the reaction with a relatively low temperature allows the number of generated cores to be reduced sufficiently and the particle size to be relatively large, and the subsequent temperature increase allows sufficient crystallization. After the process described above, intended Bi₁₂MO₂₀ particles may be obtained by removing liquid component, washing, and finally drying. Preferably, the average particle diameter of the obtained Bi₁₂MO₂₀ particles is greater than 2 μm and smaller than 20 μm, and more preferably less than 10 μm.

A structure of a radiation imaging panel having a photoconductive layer manufactured by the manufacturing method of the present invention will now be described. Two types of radiation imaging panels are available. One of which is a direct conversion type in which radiation is directly converted to charges and stored, and the other of which is an indirect conversion type in which radiation is first converted to light by a scintillator, such as CsI, and then the light is converted to charges by an amorphous-Si photodiode. The photoconductive layer obtained by the manufacturing method of the present invention may be used in the former direct conversion type. As for the radiation, γ rays and α rays may be used other than X-rays.

Further, the photoconductive layer manufactured by the manufacturing method of the present invention may be used for the following two readout types, one of which is a method in which charges generated by the emission of radiation are stored and the stored charges are read out by ON/OFF switching an electric switch, such as a thin film transistor (TFT) or the like, with respect to each pixel (hereinafter, “TFT readout type”) and the other of which is a so-called an optical readout type in which image reading is performed using a radiation image detector of a semiconductor material that generates charges when exposed to light.

An example of the former TFT readout type radiation imaging panel may be the panel described in paragraphs [0067] to [0073] of Japanese Unexamined Patent Publication No. 2006-096657. The photoconductive layer manufactured by the manufacturing method of the present invention may be used as radiation conductive layer 104 of the radiation imaging panel shown in FIG. 6. An example of the latter optical readout type radiation imaging panel may be the panel described in paragraphs [0051] to [0066] of Japanese Unexamined Patent Publication No. 2006-096657. The photoconductive layer manufactured by the manufacturing method of the present invention may be used as recording radiation conductive layer 2 of the radiation imaging panel shown in FIG. 1. Hereinafter, Examples of manufacturing methods of photoconductive layers of radiation imaging panels of the present invention.

### Example 1

One liter of solution including Bi element with a concentration of 1.2 mol/l (Bi solution: B-1) was prepared by dissolving 279.6 g of bismuth oxide (Kojundo Chemical Laboratory Co., Ltd, Purity of 5N) using 474.4 g of nitric acid (Wako Pure Chemical Industries, Ltd., concentration of 61.1 wt %) and deionized water. Separately, one liter of solution including Si element with a concentration of 0.1 mol/l (Si solution: S-1) was prepared by mixing 30.1 g of potassium silicate solution (Wako Pure Chemical Industries, Ltd., molar ratio: SiO₂/K₂O=3.9, concentration of 28.0%), 700 ml of potassium hydroxide solution (Wako Pure Chemical Industries, Ltd., 8N), and deionized water together. Further, 500 ml of alkali mother liquor (mother liquor: M-1) was prepared using 62.5 ml of potassium hydroxide solution (Wako Pure Chemical Industries, Ltd., 8N) and deionized water.

Then, Bi₁₂MO₂₀ particles were synthesized in reaction vessel 10 shown in FIG. 3 using the solution prepared in the manner described above. 50 ml of mother liquor (M-1) was introduced into Teflon® coated reaction vessel 11 and while Teflon® coated agitation unit 16 is being operated in the mother liquor (M-1) at 1000 rpm, the temperature of the mother liquor (M-1) was increased to 50° C. Then, Bi solution (B-1, 50 ml) in solution tank 14a and Si solution (S-1, 50 ml) in solution tank 14b were simultaneously introduced into the inside of the cylinder of agitation unit 16 via solution flow paths 15a and 15b respectively at a rate of 10 ml/min for five minutes. During the introduction of the solutions, the temperature of the mixed solution in reaction vessel 11 was maintained at 50° C. After the addition of the solutions, the temperature of the mixed solution was increased to 75° C. at a rate of 2.5° C./min for 10 minutes. After the temperature was increased to 75° C., the mixed solution was agitated for 120 minutes at 75° C.

After the agitation, the entire reaction system was cooled to room temperature, and the obtained deposit was filtered and washed sufficiently with deionized water. The obtained solid body was dried at 100° C. for 12 hours, whereby 12.5 g of Bi₁₂MO₂₀ particles was obtained (yield of 88%). The average particle diameter of the obtained particles was about 5 μm.

The Bi₁₂MO₂₀ particles were molded by a uniaxial press (100 MPa) and then subjected to CIP pressing (200 MPa). The molded body was put in a sealed vessel which was then vacuumed by a rotary pump, and the molded body was immersed in a solution of thermosetting resin (RTV rubber, product name: KE109, A liquid: B liquid=1:1, Shin-Etsu Chemical Co., Ltd.) under vacuum condition. Then, after taking out the molded body from the vessel and removing extra resin, the body was heated at 120° C. for two hours to solidify the resin, whereby a photoconductive layer, impregnated with the thermosetting resin, with a film thickness of 500 μm was obtained. An Au electrode was sputtered on each side of the obtained photoconductive layer, whereby a detection unit of a radiation imaging panel having a photoconductive layer of Bi₁₂MO₂₀ particles was completed.

### Example 2

A detection unit of a radiation imaging panel having a photoconductive layer of Bi₁₂MO₂₀ particles was completed in a manner similar to that of Example 1, except that the obtained Bi₁₂MO₂₀ particles were heat treated at 500° C. for two hours under the atmosphere and the heat treated particles were used.

### Example 3

A detection unit of a radiation imaging panel having a photoconductive layer of Bi₁₂MO₂₀ particles was completed in a manner similar to that of Example 1, except that the obtained Bi₁₂MO₂₀ particles were heat treated at 800° C. for two hours under the atmosphere and the heat treated particles were used.

### Example 4

A detection unit of a radiation imaging panel having a photoconductive layer of Bi₁₂MO₂₀ particles was completed in a manner similar to that of Example 1, except that the obtained Bi₁₂MO₂₀ particles were heat treated at 870° C. for two hours under the atmosphere and the heat treated particles were used. The heat treated particles were fused to each other, and therefore particles crushed by an alumina mortar and pestle were used.

### Example 5

A detection unit of a radiation imaging panel having a photoconductive layer of Bi₁₂MO₂₀ particles was completed in a manner similar to that of Example 1, except that Ti(O-i-C₃H₇)₄ was used instead of the potassium silicate.

### Example 6

A detection unit of a radiation imaging panel having a photoconductive layer of Bi₁₂MO₂₀ particles was completed in a manner similar to that of Example 1, except that Ge(O—C₂H₅)₄ was used instead of the potassium silicate.

### Example 7

A detection unit of a radiation imaging panel having a photoconductive layer of Bi₁₂MO₂₀ particles was completed in a manner similar to that of Example 1, except that the molding was performed only by a uniaxial press (100 MPa) without CIP molding.

### Example 8

A detection unit of a radiation imaging panel having a photoconductive layer of Bi₁₂MO₂₀ particles was completed in a manner similar to that of Example 7, except that the Bi₁₂MO₂₀ particles heat treated at 800° C. in Example 3 were used.

### Example 9

A photoconductive layer impregnated with the thermosetting resin was obtained in a manner similar to that of Example 1, except that the film thickness was 1.5 cm. Thereafter, the photoconductive layer impregnated with the thermosetting resin was cut into 10 slices each having a thickness of 500 μm. An Au electrode was sputtered on each side of one of the 10 slices, whereby a detection unit of a radiation imaging panel having a photoconductive layer of Bi₁₂MO₂₀ particles was completed.

### Example 10

A detection unit of a radiation imaging panel having a photoconductive layer of Bi₁₂MO₂₀ particles was completed in a manner similar to that of Example 9, except that the Bi₁₂MO₂₀ particles heat treated at 800° C. in Example 3 were used.

### Comparative Example 1

Bi₁₂MO₂₀ particles obtained in Example 1 were molded by a uniaxial press (10 MPa to 140 MPa), and then subjected to CIP molding (200 MPa). Then, the molded particles were baked at 850° C. for two hours under the atmosphere to produce a Bi₁₂SiO₂₀ sintered body. The Bi₁₂SiO₂₀ sintered body was then pasted on an ITO substrate with a silver paste, and finally Au was sputtered on the Bi₁₂SiO₂₀ sintered body as an upper electrode with a thickness of 60 nm, whereby a detection unit of a radiation imaging panel having a photoconductive layer of Bi₁₂SiO₂₀ sintered body was completed.

### Comparative Example 2

A detection unit of a radiation imaging panel having a photoconductive layer was completed in a manner similar to that of Comparative Example 1, except that Bi₁₂TiO₂₀ particles obtained in Example 2 were used instead of the Bi₁₂SiO₂₀ particles.

### Comparative Example 3

A detection unit of a radiation imaging panel having a photoconductive layer was completed in a manner similar to that of Comparative Example 1, except that Bi₁₂GeO₂₀ particles obtained in Example 3 were used instead of the Bi₁₂SiO₂₀ particles.

### Comparative Example 4

A dispersion liquid including Bi₁₂SiO₂₀ particles in a dispersion state was prepared by adding methyl ethyl ketone (MEK) to the mixture of Bi₁₂SiO₂₀ particles and thermosetting resin (RTV rubber) obtained in Example 1. The dispersion liquid was agitated sufficiently so that Bi₁₂SiO₂₀ particles were dispersed evenly, and application liquid with a mixing ratio between the thermosetting resin and Bi₁₂SiO₂₀ particles is 1:6 was prepared. The obtained application liquid was uniformly applied to a Teflon® sheet using an applicator, which is then dried and detached from the sheet. Then, the detached mixture was heated at 120° C. for two hours to solidify the resin and a photoconductive layer with a thickness of 250 μm was obtained. An Au electrode is sputtered on each side of the obtained photoconductive layer and a detection unit of a radiation imaging panel having a photoconductive layer of Bi₁₂SiO₂₀ coating film was completed.

### (Spatial Filling Rate Measurement)

A spatial filling rate of each of Examples 1 to 5 and Comparative Examples 1 to 4 was obtained by the formula below.

Spatial Filling Rate=Vx/V

(where, Vx represents the volume of Bi₁₂MO₂₀ and V represents the entire volume of the photoconductive layer)

### (Generated Charge Amount Measurement)

A 1 mR X-ray was emitted to each of Examples 1 to 10 and Comparative Examples 1 to 4 for 0.08 seconds under an electric field of 2.5V/μm, and a pulse like optical current generated with the voltage being applied is converted to a voltage by a current amplifier and observed with a digital oscilloscope. Based on a current vs time curve obtained, X-ray emission time range was integrated, which was measured as the generated charge amount.

### (Handleability Test)

Ten photoconductive layers produced in each of Examples 1 to 10 and Comparative Examples 1 to 4 were dropped on an iron plate from about 1 m above the plate to see if the photoconductive layers are broken, and the handleability was evaluated in the following manner.
Not good: if six or more out of ten photoconductive layers are broken
Good: if two or less out of ten photoconductive layers are broken

The results are summarized in Table 1. Note that the generated charge amounts are indicated by relative values with the value of Example 1 taken as 100.

TABLE 1

| | | S/fill. | Charge | |
|---|---|---|---|---|
| | Photoconductive layer Structure | rate | Amount | Handleability |
| EG 1 | Bi₁₂SiO₂₀ P/C + resin | 66 | 100 | Good |
| EG 2 | 500° C. H/T Bi₁₂SiO₂₀ P/C + resin | 66 | 110 | Good |
| EG 3 | 800° C. H/T Bi₁₂SiO₂₀ P/C + resin | 66 | 115 | Good |
| EG 4 | 870° C. H/T Bi₁₂SiO₂₀ P/C + resin | 69 | 120 | Good |
| EG 5 | Bi₁₂TiO₂₀ P/C + resin | 65 | 90 | Good |
| EG 6 | Bi₁₂GeO₂₀ P/C + resin | 65 | 110 | Good |
| EG 7 | Bi₁₂SiO₂₀ P/C (W/O CIP) + resin | 60 | 90 | Good |
| EG 8 | 800° C. H/T Bi₁₂SiO₂₀ P/C (W/O CIP) + | 60 | 110 | Good |
| | resin | | | |
| EG 9 | Bi₁₂SiO₂₀ P/C + resin → sliced | 66 | 100 | Good |
| EG 10 | 800° C. H/T Bi₁₂SiO₂₀ P/C + resin → | 66 | 115 | Good |
| | sliced | | | |
| C/E 1 | Bi₁₂SiO₂₀ sintered body | 80 | 120 | Not Good |
| C/E 2 | Bi₁₂TiO₂₀ sintered body | 76 | 110 | Not Good |
| C/E 3 | Bi₁₂GeO₂₀ sintered body | 80 | 130 | Not Good |
| C/E 4 | Bi₁₂SiO₂₀ P/C dispersed coating film | 50 | 70 | Good |

As is clear from Table 1, each of the photoconductive layers manufactured by the manufacturing method of the present invention is more resistant to physical impact and more handleable in comparison with the sintered body of each of Comparative Examples 1 to 3 because a macromolecular substance is present in a space between Bi₁₂MO₂₀ particles. Further, each of the photoconductive layers of the present invention has a higher spatial filling rate and generates a more amount of charges in comparison with that of the coating film of Comparative Example 4. Although each of the photoconductive layers of the present invention generates a slightly less amount of charges in comparison with that of each of sintered bodies of Comparative Examples 1 to 3, the difference is insignificant when weighing the handleability.

Each of Examples 2 to 4 is a photoconductive layer provided by heat treating the obtained Bi₁₂SiO₂₀ particles and may generate a more amount of charges in comparison with that of Example 1. From the comparison between Example 1 and Examples 2 to 4, it can be said that the heat treatment of Bi₁₂SiO₂₀ particles at a temperature in the range from 500° C. to 870° C. may reduce the grain boundaries of Bi₁₂SiO₂₀ particles, which prevents carries from being trapped when radiation is generated, whereby the amount of generated charges may be increased. In Example 4, heat treated particles were fused to each other, and particles were crushed and used, which proved that the particle fusion does not influence the amount of generated charges.

In Example 7, the molding was performed only by a uniaxial press and the spatial filling rate was slightly reduced, which shows that the combined use of uniaxial pressing and cold isostatic pressing is preferable for molding the powder compact in order to increase the filling rate. Example 9 was produced by the manufacturing method shown in FIGS. 2A to 2F and shows that it is possible to manufacture a plurality of photoconductive layers, comparable to that produced one by one, at a time even though the produced photoconductive layer was sliced, i.e., suggesting that a mass production can be realized. Examples 8 and 10 are similar to Examples 7 and 9 respectively except that heat treated Bi₁₂SiO₂₀ particles were used, and here also shows that Examples 8 and 10 using heat treated Bi₁₂SiO₂₀ particles may generate more amounts of charges in comparison with those of Examples 7 and 9 respectively.

The present invention may be advantageously used for manufacturing a photoconductive layer of a radiation imaging panel.

What is claimed is:

1. A method for manufacturing a photoconductive layer formed of Bi₁₂MO₂₀ particles (M is at least one of Si, Ge, and Ti) and constitutes a radiation imaging panel for recording radiation image information as an electrostatic latent image, the method comprising the steps of molding a powder compact of Bi₁₂MO₂₀ particles, impregnating the powder compact with a macromolecular substance, and solidifying the macromolecular substance.

2. The method of claim 1, further comprising the step of slicing the powder compact with the solidified macromolecular substance.

3. The method of claim 1, wherein the Bi₁₂MO₂₀ particles are heat treated at a temperature in the range from 500° C. to 870° C. before being molded into the powder compact.

4. The method of claim 2, wherein the Bi₁₂MO₂₀ particles are heat treated at a temperature in the range from 500° C. to 870° C. before being molded into the powder compact.

5. The method of claim 1, wherein the macromolecular substance is a thermosetting resin, an ultraviolet curable resin, or an electron beam curable resin.

6. The method of claim 2, wherein the macromolecular substance is a thermosetting resin, an ultraviolet curable resin, or an electron beam curable resin.

7. The method of claim 3, wherein the macromolecular substance is a thermosetting resin, an ultraviolet curable resin, or an electron beam curable resin.

8. The method of claim 4, wherein the macromolecular substance is a thermosetting resin, an ultraviolet curable resin, or an electron beam curable resin.

9. The method of claim 1, wherein the powder compact is molded by uniaxial pressing and/or cold isostatic pressing.

10. The method of claim 2, wherein the powder compact is molded by uniaxial pressing and/or cold isostatic pressing.

11. The method of claim 3, wherein the powder compact is molded by uniaxial pressing and/or cold isostatic pressing.

12. The method of claim 4, wherein the powder compact is molded by uniaxial pressing and/or cold isostatic pressing.

13. The method of claim 5, wherein the powder compact is molded by uniaxial pressing and/or cold isostatic pressing.

14. The method of claim 6, wherein the powder compact is molded by uniaxial pressing and/or cold isostatic pressing.

15. The method of claim 7, wherein the powder compact is molded by uniaxial pressing and/or cold isostatic pressing.

16. The method of claim 8, wherein the powder compact is molded by uniaxial pressing and/or cold isostatic pressing.
